(19) United States
(12) Patent Application Publication
(10) Pub. No.: US 2026/0218478 A1
(43) Pub. Date: Jul. 30, 2026

(54) INJECTION PORT APPARATUSES FOR HOLLOW STRUCTURAL BLOCKS

(71) Applicant: Daniel Charles BECK, Akron, OH (US)

(72) Inventor: Daniel Charles BECK, Akron, OH (US)

(21) Appl. No.: 19/041,770

(22) Filed: Jan. 30, 2025

(51) Int. Cl. E02D 31/02; B29C 45/27; B29L 31/00

(52) U.S. Cl. CPC E02D 31/02; B29C 2045/2761; B29L 2031/776; E02D 2250/003; E02D 2300/0014; E02D 2450/00

(57) ABSTRACT

According to examples, an injection port apparatus may include a center threaded tube, a first compression gasket positioned near a first end of the center threaded tube, and a second compression gasket positioned near a second end of the center threaded tube. The injection port apparatus may also include an internally threaded tube screwed onto the second end of the center threaded tube. In addition, rotation of the internally threaded tube in a first direction with respect to the center threaded tube causes the internally threaded tube to move closer to the first end of the center threaded tube, which compresses the first compression gasket and the second compression gasket and causes diameters of the first compression gasket and the second gasket to increase. The injection port apparatus may be employed to form a waterproofing curtain wall on a foundation wall.

### BACKGROUND

Foundation walls of buildings are typically constructed from hollow concrete blocks or poured concrete, with portions of the foundation walls being located below ground. Water around the surrounding ground of the buildings is often able to penetrate the foundation walls through cracks, holes, natural pores, and other openings in the concrete blocks or poured concrete or through cracks in the mortar laid between concrete blocks. The seepage of water into the buildings through below-ground foundation walls is highly undesirable as the water may lead to various negative consequences, including structural damage, moisture-related issues, material deterioration, mold growth, and mildew growth.

### BRIEF DESCRIPTION OF THE DRAWINGS

Features of the present disclosure are illustrated by way of example and not limited in the following figure(s), in which like numerals indicate like elements, in which:

FIG. 1 shows a cross-sectional side view of a hollow structural block, in which an injection port apparatus has been inserted through holes formed in the hollow structural block, in accordance with an embodiment of the present disclosure;

FIG. 2 shows a cross-sectional side view of the injection port apparatus shown in FIG. 1, in accordance with an embodiment of the present disclosure;

FIG. 3 shows an exploded view of the injection port apparatus shown in FIGS. 1 and 2, in accordance with an embodiment of the present disclosure;

FIG. 4A shows a front view of an internally threaded tube of the injection port apparatus shown in FIGS. 1-3, in accordance with an embodiment of the present disclosure;

FIG. 4B shows a front view of an adapter to be used with the injection port apparatus shown in FIGS. 1-3, in accordance with an embodiment of the present disclosure;

FIG. 4C shows a rear view of a second side of the adapter shown in FIG. 4B, in accordance with an embodiment of the present disclosure; and

FIGS. 5A-5D, collectively, show operations in a method of forming a curtain wall on a below-ground foundation wall that is formed of hollow structural blocks, in accordance with an embodiment of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, some methods and structures have not been described in detail so as not to unnecessarily obscure the present disclosure.

Throughout the present disclosure, the terms “a” and “an” are intended to be at least one of a particular element. As used herein, the term “includes” means includes but not limited to, the term “including” means including but not limited to. The term “based on” means based at least in part on.

Numerous types of systems and methods have been developed for waterproofing below-ground foundation walls. Many of these methods include forming a trench along the outside of a foundation wall and applying filler material or other type of waterproofing material to form a curtain wall along the outside of the foundation wall. These methods are highly labor-intensive and often require the use of large equipment, such as backhoes. As a result, these methods are typically cost and time-intensive.

Other methods include drilling holes through mortar joints between hollow structural blocks from inside the foundation wall and pumping filler material through the drilled holes. An issue with these methods is that the mortar joints often do not have the ability to handle the pressures applied to the mortar joints during the drilling process and may thus crumble. As a result, use of these methods may compromise the structural integrity of the mortar joints and the foundation wall itself. In addition, the filler material may leak out of the holes as well as through seams or cracks in the mortar joints as the filler material is supplied through the holes.

Disclosed herein are injection port apparatuses and methods for using the injection port apparatuses to form curtain walls on foundation walls through injection of filler material through hollow structural blocks that form the foundation walls. The injection port apparatuses disclosed herein may be inserted into holes formed into the side walls of the hollow structural blocks such that the filler material may be injected through the injection port apparatuses. In addition, the injection port apparatuses may include compression gaskets that may be positioned within the holes in the side walls. The injection port apparatuses may also include components to longitudinally compress the compression gaskets causing the compression gaskets to expand within the holes of the side walls. The compression gaskets may thus seal the holes in the side walls of the hollow structural blocks and may securely seat the injection port apparatuses within the hollow structural blocks during injection of filler material through the injection port apparatuses. Following injection of filler material through the injection port apparatuses, portions of the injection port apparatuses may remain within the hollow structural blocks.

Through implementation of the features of the present disclosure to employ injection port apparatuses to inject filler material through hollow structural blocks, a curtain wall along a side of a foundation wall facing the ground may be formed in a relatively convenient manner. For instance, the curtain wall may be formed without requiring that ground adjacent the foundation wall be removed. Additionally, the filler material may be injected through a hollow structural block while reducing or preventing the seepage of the filler material back through the hollow structural block.

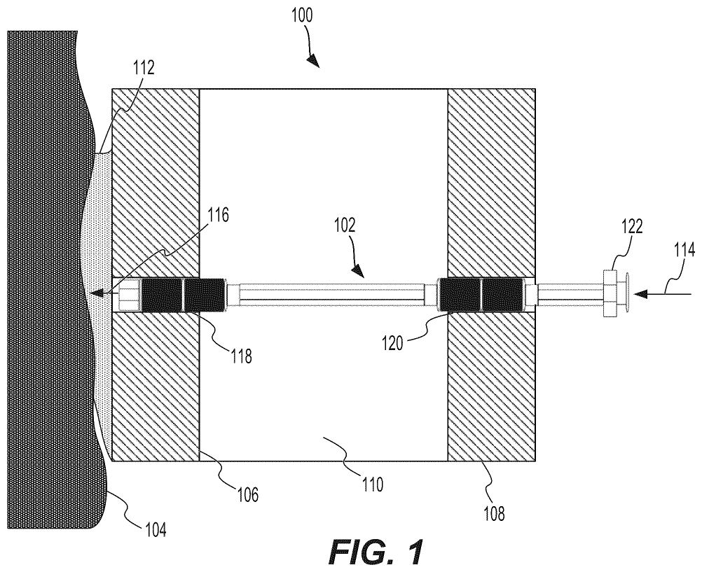

FIG. 1 shows a cross-sectional side view of a hollow structural block 100, in which an injection port apparatus 102 has been inserted through holes formed in the hollow structural block 100, in accordance with an embodiment of the present disclosure. In some examples, the hollow structural block 100 may be a hollow concrete block, such as a concrete masonry unit (CMU). In other examples, the hollow structural block 100 may be formed of other materials such as concrete mixed with sawdust, concrete mixed with fly ash, hempcrete, compressed earth blocks, ferrock, or the like. The hollow structural block 100 is depicted as being positioned adjacent a surrounding ground 104, and particularly as being positioned as a block in a foundation wall of a building. In this regard, additional hollow structural blocks may be positioned on at least one of the top, bottom, and side of the hollow structural block 100, with mortar (not shown) laid between the hollow structural blocks to lock them together.

The hollow structural block 100 includes a first side wall 106 and a second side wall 108, with a space 110 provided between the first side wall 106 and the second side wall 108. As discussed herein, water may seep from the surrounding ground 104 and through the walls 106, 108 of the hollow structural block 100 or the mortar provided between adjacent hollow structural blocks 100. In order to prevent or reduce the amount of water seepage through the foundation wall, a filler or sealant material 112 may be applied to a side of the hollow structural block 100 that faces the ground 104. The filler material 112 may be a hydrophobic, expanding, polyurethane, chemical grout, or the like. The filler material 112 may be in liquid form, and may expand after being injected between the ground 104 and the hollow structural block 100, for instance, up to 30 times the liquid volume, or more. In some examples, the filler material 112 may have a viscosity of up to 700 centipoise (CPS) at 74 degrees Fahrenheit, or more.

According to examples, and as shown in FIG. 1, the filler material 112 may be injected into gaps between the ground 104 and the rear side of the hollow structural block 100 through the injection port apparatus 102. As the filler material 112 is injected into the gaps, the filler material 112 may spread across some or all of the rear side of the hollow structural block 100. In addition, as the filler material 112 hardens or solidifies, the filler material 112 may form a barrier (e.g., a curtain wall) that may prevent or reduce the seepage of water or moisture through the hollow structural block 100 and the mortar between multiple ones of the hollow structural blocks 100.

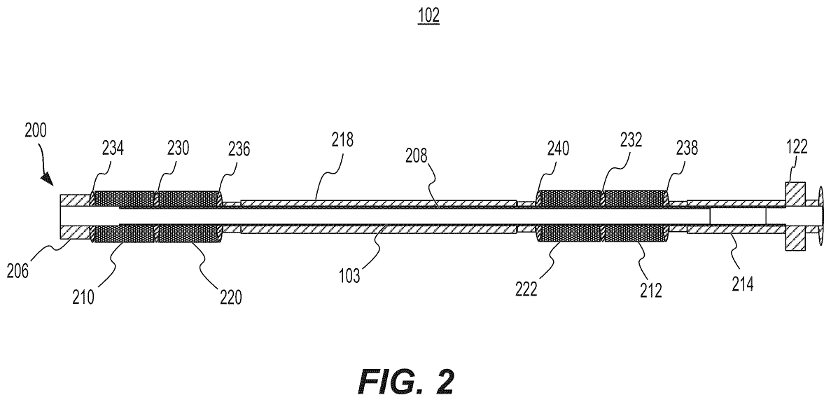

The injection port apparatus 102 may include a channel 103 (shown in FIG. 2) through which the filler material 112 may be supplied from one end of the injection port apparatus 102 to the other end of the injection port apparatus 102 as denoted by the arrows 114, 116. In addition, as discussed herein, the injection port apparatus 102 may seal the holes through which the injection port apparatus 102 extends through the hollow structural block 100. The injection port apparatus 102 may thus enable the filler material 112 to be injected through the hollow structural block 100 with little to no loss of the filler material 112 inside of the space 110 in the hollow structural block 100.

In some examples, an injection gun (not shown) may be employed to inject the filler material 112 into the injection port apparatus 102. The injection gun may pressurize the filler material 112 such that the filler material 112 may readily flow through the injection port apparatus 102. In some examples, the injection gun may inject the filler material 112 at a relative low pressure level, e.g., around 80 bar (1200 psi) or less. In other examples, the injection gun may inject the filler material 112 at a relatively higher pressure level, e.g., around 200 bar (2900 psi). In any of these examples, an adapter 122 may be attached to the end of the injection port apparatus 102, in which the adapter 122 may provide a sealed interface for the injection gun to supply filler material into the injection port apparatus 102.

The injection port apparatus 102 may be inserted into the hollow structural block 100 before or after the hollow structural block 100 has been placed as part of a foundation wall. In either case, a first hole 118 may be formed through the first side wall 106 and a second hole 120 may be formed through the second side wall 108 and the injection port apparatus 102 may be inserted through the first and second holes 118, 120. The first hole 118 and the second hole 120 may be formed through use of any suitable tool, such as a drill with a drill bit that has a sufficient length to bore through the hollow structural block 100 and a sufficient width (or diameter) that is slightly larger than the largest width (or diameter) of the injection port apparatus 102. By way of particular non-limiting example, the drill bit may have around a ⅝″ (15.875 mm) diameter and the largest diameter of the injection port apparatus 102 may be around ½″ (13 mm).

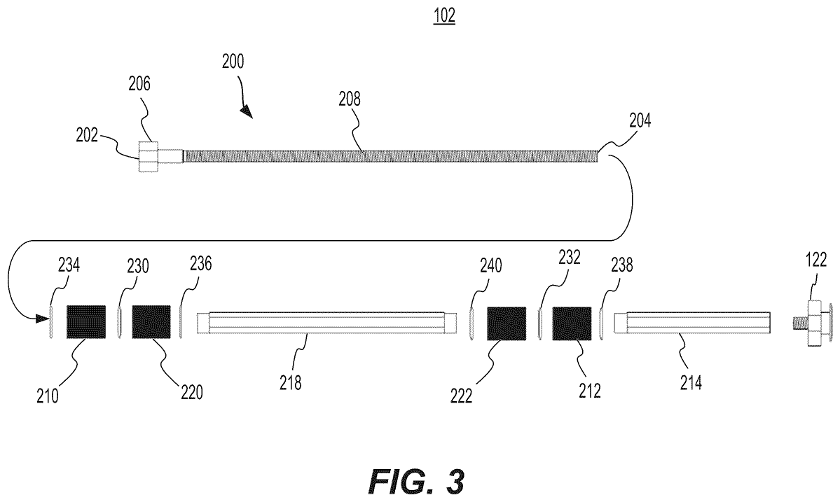

FIG. 2 shows a cross-sectional side view of the injection port apparatus 102 shown in FIG. 1, in accordance with an embodiment of the present disclosure. FIG. 3 shows an exploded view of the injection port apparatus 102 shown in FIGS. 1 and 2, in accordance with an embodiment of the present disclosure. It should be understood that the injection port apparatus 102 depicted in FIGS. 1-3 may include additional components and that some of the components described herein may be removed and/or modified without departing from the scope of the injection port apparatus 102 disclosed herein.

As shown in FIGS. 2 and 3, the injection port apparatus 102 may include a center threaded tube 200, which includes a first end 202 and a second end 204. The center threaded tube 200 may include a screw head 206 at the first end 202 and threads 208 along a portion of the center threaded tube 200. According to examples, the screw head 206 may be an end nut that is screwed onto the portion of the center threaded tube 200 having the threads 208. In other examples, the screw head 206 may be integrally formed or otherwise bonded to the portion of the center threaded tube 200 having the threads 208, for instance, through use of welds, adhesives, or the like.

In either of these examples, the screw head 206 may include external tooth lock elements along the side of the screw head 206 that faces toward the second end 204. In other words, the screw head 206 may be a lock nut that may prevent loosening due to vibration or torque, which may ensure that the injection port apparatus 102 remains stable and tightly fastened within the first hole 118. Although the threads 208 are depicted as extending for most of the length of the center threaded tube 200, the threads 208 may extend for a relatively shorter distance near the second end 204 without departing from a scope of the present disclosure.

As shown in FIG. 2, the center threaded tube 200 may be hollow from the first end 202 to the second end 204 to enable the filler material 112 to flow through the center threaded tube 200. In addition, the screw head 206 may be sized to enable the screw head 206 to securely be held within the first hole 118 when the screw head 206 is inserted in the first hole 118 as shown in FIG. 1. Particularly, the screw head 206 may be sized (or the first hole 118 may be sized) to enable the screw head 206 to be inserted into the first hole 118 while also preventing the screw head 206 from rotating about the longitudinal axis of the center threaded tube 200. As a result, during operation, the screw head 206 may maintain alignment and integrity of the injection port apparatus 102 by holding all of the components of the injection port apparatus 102 firmly together.

The injection port apparatus 102 may also include a first compression gasket 210 positioned near the first end 202 of the center threaded tube 200 and a second compression gasket 212 positioned near the second end 204 of the center threaded tube 200. The center threaded tube 200 may extend through both the first compression gasket 210 and the second compression gasket 212. The first compression gasket 210 may also be positioned along the injection port apparatus 102 to be positioned within the first hole 118 of the hollow structural block 100 as shown in FIG. 1. In addition, the second compression gasket 212 may be positioned along the injection port apparatus 102 to be positioned within the second hole 120 of the hollow structural block 100 as also shown in FIG. 1.

By way of particular non-limiting example in which the hollow structural block 100 is a typical concrete masonry unit having dimensions of 8 inches (203 mm)×16 inches (406 mm)×8 inches (203 mm), the injection port apparatus 102 may have a length of around 9.75 inches (248 mm). In addition, in examples in which the first side wall 106 and the second side wall 108 have widths around 1.5 inches, each of the first compression gasket 210 and the second compression gasket 212 may have widths of around 1 inch to about 1.5 inches. In an example, the first compression gasket 210 may be longer than the width of the first side wall 106. In an example, the second compression gasket 212 may be longer than the width of second side wall 108. In an example, the first compression gasket 210 may be shorter than the width of the first side wall 106. In an example, the second compression gasket 212 may be shorter than the width of second side wall 108.

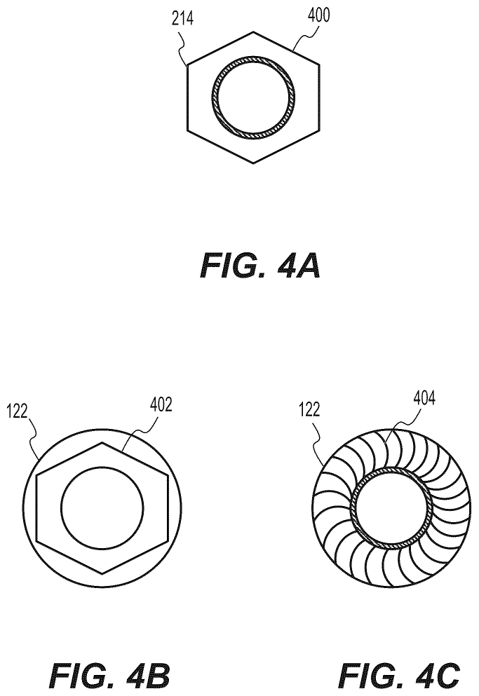

An internally threaded tube 214 may be screwed onto the second end 204 of the center threaded tube 200 as shown in FIG. 2. The internally threaded tube 214 may be formed of any suitable material, such as aluminum. In some examples, the internally threaded tube 214 may have multiple faces 400 as shown in FIG. 4A, which shows a front view of the internally threaded tube 214 according to an embodiment of the present disclosure. The faces 400 enable a tool, such as a wrench or socket to engage the internally threaded tube 214 and enable rotation of the internally threaded tube 214 on the threads 208 of the center threaded tube 200. In some examples, the center threaded tube 200 may accommodate and securely attach any of a number of various injection heads through use of adapters 122. For instance, the center threaded tube 200 may enable an adapter 122, such as, a zerk fitting injection head, a button head fitting injection head, or the like, to be employed with the injection port apparatus 102.

During operation, the center threaded tube 200 may be held in place, e.g., prevented from rotating, through a friction fit of the screw head 206 within the first hole 118 of the first side wall 106 as shown in FIG. 1. As a result, as the internally threaded tube 214 is rotated in a first direction, e.g., clock-wise in FIG. 1, the internally threaded tube 214 may move toward the screw head 206. In moving toward the screw head 206, the internally threaded tube 214 may apply longitudinal pressure onto the second compression gasket 212 and the first compression gasket 210.

In addition, longitudinal movement of the first compression gasket 210 and the second compression gasket 212 along the center threaded tube 200 may be blocked as discussed herein, which may cause the first compression gasket 210 and the second compression gasket 212 to expand laterally (or equivalently, radially) as the first compression gasket 210 and the second compression gasket 212 are compressed. The increase of the diameters of the first compression gasket 210 and the second compression gasket 212 may cause the first compression gasket 210 to better seal the first hole 118 in the first side wall 106 and the second compression gasket 212 to better seal the second hole 120 of the second side wall 108. As a result, the injection port apparatus 102 may securely be seated within the first hole 118 and the second hole 120 and may block filler material 112 from seeping through the first hole 118 and the second hole 120.

According to examples, the injection port apparatus 102 may include a smooth bore tube 218 positioned between the first compression gasket 210 and the second compression gasket 212. The smooth bore tube 218 may include a smooth bore such that the smooth bore tube 218 may relatively freely move longitudinally with respect to the center threaded tube 200. Additionally, the smooth bore tube 218 may maintain separation between the first compression gasket 210 and the second compression gasket 212 as the internally threaded tube 214 is moved with respect to the screw head 206. In addition, the smooth bore tube 218 may create resistance and apply compressive force to the first compression gasket 210 and the second compression gasket 212. According to examples, the smooth bore tube 218 may be made of aluminum, although in other examples, the smooth bore tube 218 may be made of other relatively stiff materials.

According to examples, the injection port apparatus 102 may include a third compression gasket 220 positioned adjacent to the first compression gasket 210. Particularly, the third compression gasket 220 may be positioned on the center threaded tube 200 between the first compression gasket 210 and the smooth bore tube 218. The injection port apparatus 102 may also include a fourth compression gasket 222 positioned on the center threaded tube 200 between the second compression gasket 212 and the smooth bore tube 218. Each of the first to fourth compression gaskets 210, 212, 220, 222 may include smooth bores to enable the compression gaskets 210, 212, 220, 222 to readily move over the threads 208 of the center threaded tube 200. In addition, the third compression gasket 220 and the fourth compression gasket 222 may also be compressed responsive to movement of the internally threaded tube 214 toward the first end 202 of the center threaded tube 200. The inclusion of the third and fourth compression gaskets 220, 222 may enable the injection port apparatus 102 to be better seated respectively within the first and second holes 118, 120.

Each of the compression gaskets 210, 212, 220, 222 may be compressible tubes and may be made of a resilient material. By way of particular example, the compression gaskets 210, 212, 220, 222 may be formed of ethylene propylene diene monomer (EPDM), reinforced rubber, or the like. In examples in which the first side wall 106 and the second side wall 108 have widths around 1.5 inches, each of the compression gaskets 210, 212, 220, 222 may have widths of around 0.5 inches to about 1 inch. In addition, the compression gaskets 210, 212, 220, 222 may have diameters of around 0.5 inches. In an example, the combined length of the first compression gasket 210 and third compression gasket 220 may be longer than the width of the first side wall 106. In an example, the combined length of the second compression gasket 212 and the fourth compression gasket 222 may be longer than the width of second side wall 108. In an example, the combined length of the first compression gasket 210 and third compression gasket 220 may be shorter than the width of the first side wall 106. In an example, the combined length of the second compression gasket 212 and the fourth compression gasket 222 may be shorter than the width of second side wall 108.

The injection port apparatus 102 may also include a plurality of washers 230-240 positioned on the center threaded tube 200 and between various components of the injection port apparatus 102. Particularly, the injection port apparatus 102 may include a first washer 230 positioned between the first compression gasket 210 and the third compression gasket 220. The injection port apparatus 102 may also include a second washer 232 positioned between the second compression gasket 212 and the fourth compression gasket 222. The injection port apparatus 102 may further include a third washer 234 positioned between the first compression gasket 210 and the screw head 206 and a fourth washer 236 positioned between the third compression gasket 220 and the smooth bore tube 218. The injection port apparatus 102 may still further include a fifth washer 238 positioned between the second compression gasket 212 and the internally threaded tube 214 and a sixth washer 240 positioned between the fourth compression gasket 222 and the smooth bore tube 218.

Each of the washers 230-240 may have a thin, disk-shape with a central hole into which the center threaded tube 200 may be inserted. The washers 230-240 may laterally distribute compressive forces across the compressive gaskets 210, 212, 220, 222 and may thus protect them. The washers 230-240 may also enhance the overall stability and performance of the injection port apparatus 102, ensuring consistent compression gasket 210, 212, 220, 222 expansion and maintaining tight seals in the first hole 118 and the second hole 120. By way of non-limiting example, the washers 230-240 may have diameters of around 0.5 inches.

In some examples, an adapter 122, for instance, for a filler material injection gun, to be employed with the injection port apparatus 102. The adapter 122 may be screwed into an end of the internally threaded tube 214 opposite from one or more of the compression gaskets 212 and 222 as also shown in FIG. 2. In these examples, the adapter 122 may be rotated in a direction that causes the adapter 122 to be moved in closer proximity to the internally threaded tube 214 until the adapter 122 is in contact with an end of the internally threaded tube 214. In addition, further rotation of the adapter 122 may cause the internally threaded tube 214 to rotate with the adapter 122.

FIG. 4B shows a front view of the adapter 122 shown in FIGS. 1-3, in accordance with an embodiment of the present disclosure. FIG. 4C shows a rear view of the adapter 122 shown in FIGS. 1-3, in accordance with an embodiment of the present disclosure. As shown in FIG. 4B, the adapter 122 may include a plurality of faces 402, which may enable a tool, such as a wrench or socket to engage the adapter 122 and enable rotation of the adapter 122. As shown in FIG. 4C, the adapter 122 may also include an external tooth lock washer, e.g., locking elements 404, that may reduce slippage with the internally threaded tube 214 during rotation of the adapter 122.

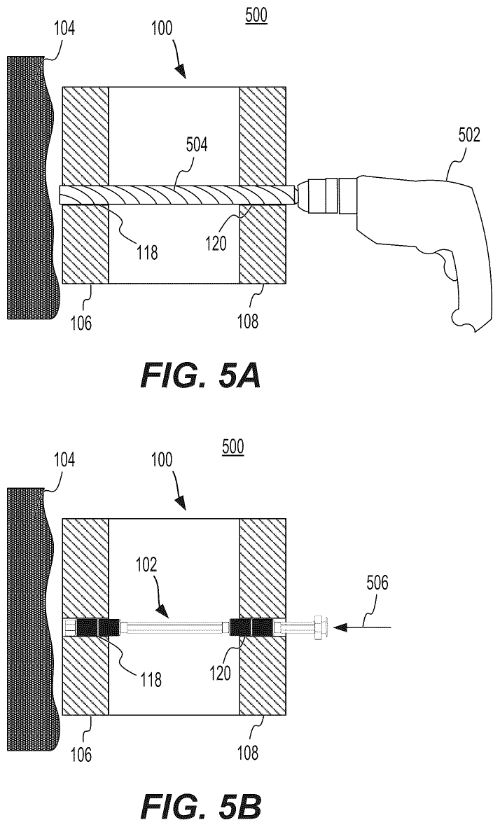

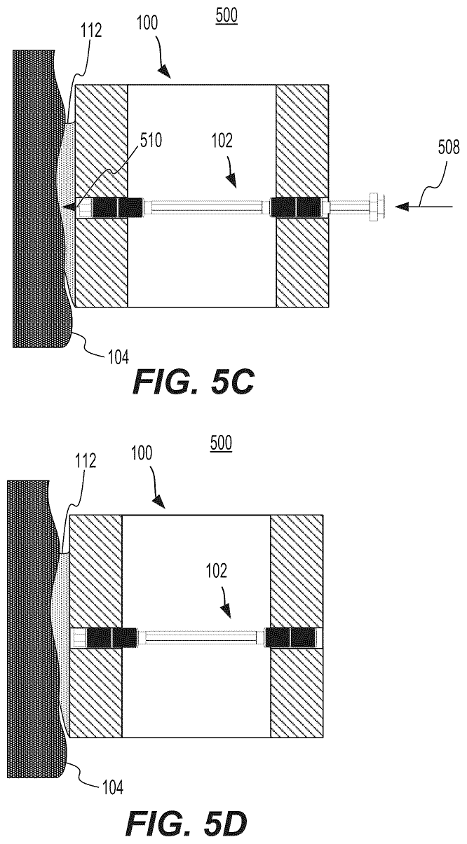

FIGS. 5A-5D, collectively, show operations in a method 500 of forming a curtain wall on a below-ground foundation wall that is formed of hollow structural blocks 100, in accordance with an embodiment of the present disclosure. It should be understood that the operations shown in FIGS. 5A-5D may include additional operations and that some of the operations described herein may be removed and/or modified without departing from the scope of the method 500 disclosed herein.

As shown in FIG. 5A, first and second holes 118, 120 may be made in the first and second side walls 106 and 108 of a hollow structural block 100. The first and second holes 118, 120 may be made through use of an electric drill 502 and a drill bit 504 having a sufficient length to pass through both of the first and second side walls 106, 108. The drill bit 504 may also have a sufficient diameter to enable an injection portion apparatus 102 to be inserted into the holes 118, 120 and for the screw head 206 to be held and prevented from rotational movement within the first hole 118 as discussed herein. The diameter of the drill bit 504 may also be of sufficient width to enable the compression gaskets 210, 212, 220, 222 to respectively seal the first and second holes 118, 120 when the compression gaskets 210, 212, 220, 222 are compressed longitudinally as discussed herein.

As shown in FIG. 5B, the drill bit 504 may be removed from the first and second holes 118, 120 and the injection port apparatus 102 may be inserted into the first and second holes 118, 120. For instance, the injection port apparatus 102 may be inserted through the second hole 120 in the direction denoted by the arrow 506. In addition, follow insertion of the injection port apparatus 102 into the first hole 118 and the second hole 120, the internally threaded tube 214 may be rotated in a direction with respect to the center threaded tube 200 that causes the internally threaded tube 214 to be moved longitudinally toward the screw head 206. The internally threaded tube 214 may be moved to cause the first compression gasket 210 and the second compression gasket 212 to be sufficiently compressed to cause the first compression gasket 210 to seal the first hole 118 and the second compression gasket 212 to seal the second hole 120. In some examples, the internally threaded tube 214 may be rotated through rotation of the adapter 122.

In some examples, the injection port apparatus 102 may include a third compression gasket 220 and a fourth compression gasket 222 as discussed herein. In these examples, the third compression gasket 220 and the fourth compression gasket 222 may respectively expand within the first hole 118 and the second hole 120 when they are compressed with movement of the internally threaded tube 214. The injection port apparatus 102 may also include the smooth bore tube 218 and the washers 230-240 as discussed herein.

As shown in FIG. 5C, filler material 112 may be injected into the injection port apparatus 102 as denoted by the arrow 508. As discussed herein, an injection gun may be used to inject or pump the filler material 112 into the injection port apparatus 102. In addition, the filler material 112 may flow through the channel 103 (FIG. 2) in the injection port apparatus 102 and may exit the injection port apparatus 102 through the screw head 206 as denoted by the arrow 510. As discussed herein, the filler material 112 may fill gaps between the ground 104 and the rear side of the hollow structural block 100. As a result, the filler material 112 may also fill in holes and cracks in the rear side of the hollow structural block 100.

As discussed herein, the first compression gasket 210 is expanded to seal the first hole 118 and the second compression gasket 212 is expanded to seal the second hole 120. The first compression gasket 210 (and, in some instances, the third compression gasket 220) may prevent the filler material 112 from seeping back into the space 110 through the first hole 118. In addition, the first compression gasket 210 (and, in some instances, the third compression gasket 220) and the second compression gasket 212 (and, in some instances, the fourth compression gasket 222) may securely lock the injection port apparatus 102 within the first and second holes 118, 120.

As shown in FIG. 5D, the internally threaded tube 214 and the adapter 122 may be removed from the injection port apparatus 102. The second hole 120 may be filled in with grout or other material, for instance, for aesthetic purposes. In addition, the remaining components of the injection port apparatus 102 may remain within the hollow structural block 100. In an example, the remaining components of the injection port apparatus 102 may remain within the hollow structural block 100 and does not negatively affect the structural integrity of the structural block 100.

According to examples, the method 500 may be repeated at multiple locations in the hollow structural block 100 as well as in additional hollow structural blocks 100 that form the foundation wall. As the filler material 112 hardens, the filler material 112 may form a waterproofing curtain wall on the rear side of the hollow structural block 100 and the foundation wall.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An injection port apparatus comprising:
a center threaded tube;
a first compression gasket positioned near a first end of the center threaded tube;
a second compression gasket positioned near a second end of the center threaded tube; and
an internally threaded tube screwed onto the second end of the center threaded tube, wherein rotation of the internally threaded tube in a first direction with respect to the center threaded tube causes the internally threaded tube to move closer to the first end of the center threaded tube, and wherein the movement of the internally threaded tube compresses the first compression gasket and the second compression gasket and causes diameters of the first compression gasket and the second compression gasket to increase.

2. The injection port apparatus of claim 1, further comprising:
a third compression gasket positioned adjacent to the first compression gasket; and
a fourth compression gasket positioned adjacent to the second compression gasket, wherein the third compression gasket and the fourth compression gasket are compressed responsive to movement of the internally threaded tube toward the first end of the center threaded tube.

3. The injection port apparatus of claim 2, further comprising:
a first washer positioned between and adjacent to the first compression gasket and the third compression gasket; and
a second washer positioned between and adjacent to the second compression gasket and the fourth compression gasket.

4. The injection port apparatus of claim 1, wherein the center threaded tube comprises a screw head at the first end of the center threaded tube and threads that extend longitudinally away from the screw head.

5. The injection port apparatus of claim 1, further comprising:
a smooth bore tube positioned between the first compression gasket and the second compression gasket, wherein a portion of the center threaded tube extends through the smooth bore tube.

6. The injection port apparatus of claim 5, further comprising:
a third washer positioned between the screw head and the first compression gasket; and
a fourth washer positioned between the third compression gasket and a smooth bore tube.
a fifth washer positioned between the second compression gasket and the internally threaded tube; and
a sixth washer positioned between the fourth compression gasket and the smooth bore tube.

7. The injection port apparatus of claim 1, wherein the first compression gasket and the second compression gasket are formed of a resilient material.

8. The injection port apparatus of claim 1, wherein the injection port apparatus is to be inserted into a first hole formed in a first side wall and a second hole formed in a second side wall of a hollow structural block, and wherein the first compression gasket is to be positioned within the first hole and the second compression gasket is to be positioned within the second hole when the injection port apparatus is seated in the hollow structural block.

9. The injection port apparatus of claim 1, further comprising:
an adapter screwed into the internally threaded tube at an end of the internally threaded tube opposite the center threaded tube, wherein the adapter is to provide a sealed interface for a filler material injection gun.

10. The injection port apparatus of claim 1, wherein the internally threaded tube has multiple faces to enable a tool to engage the internally threaded tube and enable rotation of the internally threaded tube on the threads of the center threaded tube.

11. An injection port apparatus for a hollow structural block having a first side wall and a second side wall separated by a space, the injection port apparatus comprising:
a center threaded tube having a screw head, a first end, and a second end;
a first compression gasket positioned on the center threaded tube near the screw head, wherein the first compression gasket is to be positioned within a first hole in the first side wall of the hollow structural block;
a second compression gasket positioned on the center threaded tube near the second end, wherein the second compression gasket is to be positioned within a second hole in the second side wall of the hollow structural block;
a smooth bore tube positioned between the first compression gasket and the second compression gasket; and
an internally threaded tube screwed onto the second end of the center threaded tube, wherein rotation of the internally threaded tube in a first direction with respect to the center threaded tube causes the internally threaded tube to move closer to the first end of the center threaded tube, and wherein the movement of the internally threaded tube compresses the first compression gasket and the second compression gasket and causes diameters of the first compression gasket and the second compression gasket to increase within the first hole and the second hole, respectively.

12. The injection port apparatus of claim 11, further comprising:
a third compression gasket positioned between the first compression gasket and the smooth bore tube; and
a fourth compression gasket positioned between the smooth bore tube and the second compression gasket, wherein the third compression gasket and the fourth compression gasket are also compressed responsive to movement of the internally threaded tube toward the first end of the center threaded tube and diameters of the third compression gasket and the fourth compression gasket increase within the first hole and the second hole, respectively.

13. The injection port apparatus of claim 12, further comprising:
a first washer positioned between and adjacent to the first compression gasket and the third compression gasket; and
a second washer positioned between and adjacent to the second compression gasket and the fourth compression gasket.

14. The injection port apparatus of claim 13, further comprising:
a third washer positioned between the screw head and the first compression gasket;
a fourth washer positioned between the third compression gasket and the smooth bore tube;
a fifth washer positioned between the second compression gasket and the internally threaded tube; and
a sixth washer positioned between the fourth compression gasket and the smooth bore tube.

15. The injection port apparatus of claim 11, wherein the internally threaded tube has multiple faces to enable a tool to engage the internally threaded tube and enable rotation of the internally threaded tube on the threads of the center threaded tube.

16. The injection port apparatus of claim 12, wherein the first compression gasket, the second compression gasket, the third compression gasket, and the fourth compression gasket are formed of a resilient material.

17. The injection port apparatus of claim 11, further comprising:
an adapter screwed into the internally threaded tube at an end of the internally threaded tube opposite the center threaded tube, wherein the adapter is to provide a sealed interface for a filler material injection gun.

18. A method of forming a curtain wall on a below-ground foundation wall comprising hollow structural blocks, the method comprising:
forming a first hole in a first side wall and a second hole in a second side wall of a hollow structural block of the hollow structural blocks;
inserting an injection port apparatus into the first hole and the second hole, wherein the injection port apparatus comprises:
a center threaded tube having a screw head, a first end, and a second end;
a first compression gasket positioned on the center threaded tube and within the first hole;
a second compression gasket positioned on the center threaded tube and within the second hole;
a smooth bore tube positioned between the first compression gasket and the second compression gasket; and
an internally threaded tube screwed onto the second end of the center threaded tube; and
rotating the internally threaded tube in a first direction with respect to the center threaded tube to cause the internally threaded tube to move closer to the first end of the center threaded tube, wherein movement of the internally threaded tube compresses the first compression gasket and the second compression gasket and causes diameters of the first compression gasket and the second compression gasket to increase within the first hole and the second hole, respectively.

19. The method of claim 18, further comprising:
injecting a filler material through the internally threaded tube, wherein the filler material is ejected through the screw head.

20. The method of claim 18, further comprising:
removing the internally threaded tube from the injection port apparatus.
